(19) United States
(12) Patent Application Publication
(10) Pub. No.: US 2019/0145445 A1
(43) Pub. Date: May 16, 2019

(54) CLAMPING ASSEMBLY

(71) Applicant: David L. McClung, Des Moines, IA (US)

(72) Inventor: David L. McClung, Des Moines, IA (US)

(21) Appl. No.: 16/181,654

(22) Filed: Nov. 6, 2018

Related U.S. Application Data
(63) Continuation-in-part of application No. 15/812,215, filed on Nov. 14, 2017.

(51) Int. Cl. F16B 2/18

(52) U.S. Cl. CPC F16B 2/18; B63H 25/38

(57) ABSTRACT

A clamp assembly for connecting a rudder to an aquatic device having a body with a first end, a second end, a top and a bottom. A slot, having more than one section extends into the body from the first end. A clamp having a screw connected to a pivot pin disposed within a clamp head is removably connected to the top of the body for selectively applying a clamping force within the slot.

### CROSS-REFERENCE

This application is a continuation-in-part of pending application Ser. No. 15/812,215, filed Nov. 14, 2017, the contents of this application is hereby incorporated by reference in its entirety.

### BACKGROUND OF THE INVENTION

The present invention is directed to a clamping assembly, and more particularly, a clamping assembly for connecting a rudder to an aquatic device.

Rudders for use with aquatic devices such as paddle boards, surf boards, and the like are well-known in the art. On occasion, rudders break and/or need to be replaced or they need to be removed for transportation and storage. Presently this process is difficult requiring the use of a number of small pieces that need to be aligned that can easily become lost in cold, wet, and sandy conditions. Not only is the process difficult and time consuming, it is also frustrating.

Another issue present in the art is allowing for the fine-tune adjustment of the rudder's position on the aquatic device. Currently, there is no simple and straightforward way to accomplish such adjustments. As a result, the rudder is maintained in a constant position that may not be suitable for all water and wave conditions.

Therefore, a need exists in the art for an assembly that addresses these deficiencies.

An objective of the present invention is to provide a clamp assembly that provides a quick and easy connection for a rudder.

Another objective of the present invention is to provide a clamp assembly where parts are difficult to lose.

These and other objectives will be apparent to those skilled in the art based upon the following written description, claims, and drawings.

### SUMMARY OF THE INVENTION

A clamp assembly for connecting a rudder to an aquatic device includes a body having a top, a bottom, a first end, and a second end. Extending inwardly from the first end is a slot which forms a finger along the bottom of the body.

Connected to the top of the body, above the slot, is a clamp having a clamp head and a clamp handle. Disposed within the clamp head is a pivot pin. Transversely connected to the pivot pin, and extending outwardly from the pivot pin and clamp head, is a screw. The screw extends through the body and slot.

### BRIEF DESCRIPTION OF THE DRAWINGS

FIG. 1 is a side view of a clamp assembly connecting a rudder to an aquatic device;

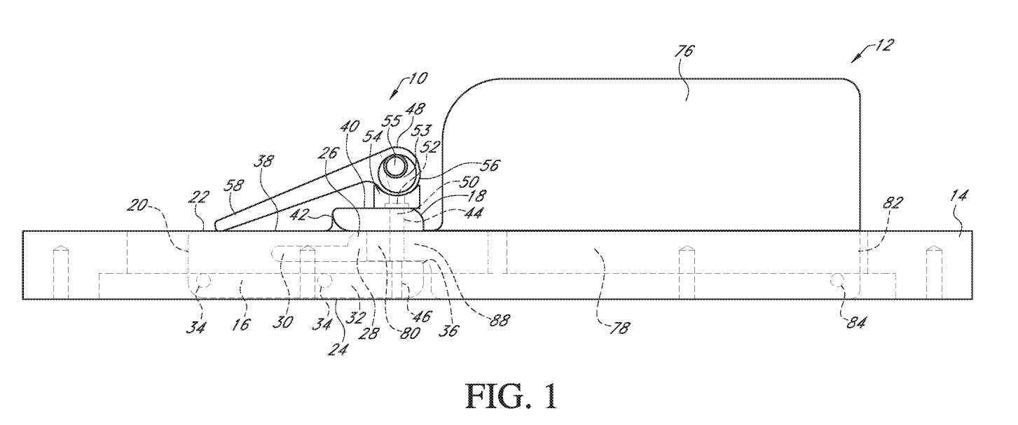

FIG. 2 is a bottom plan view of a clamp assembly connecting a rudder to an aquatic device;

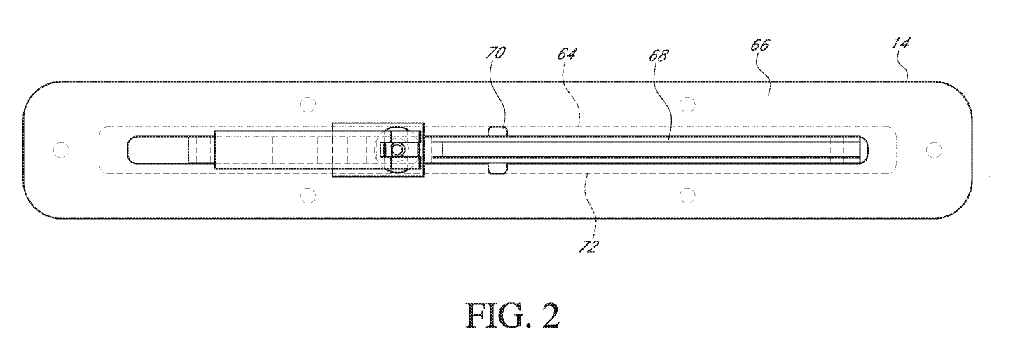

FIG. 3 is a side view of a body of a clamp assembly;

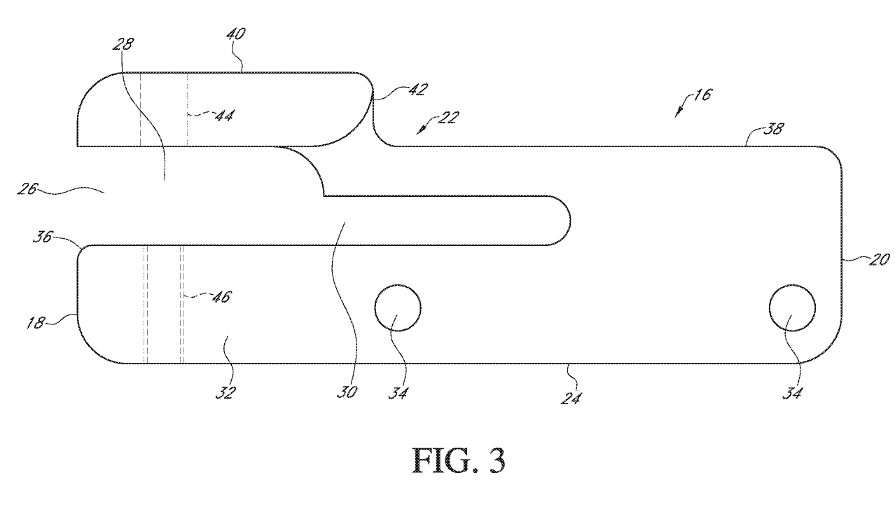

FIG. 4 is a side view of a clamp of a clamp assembly;

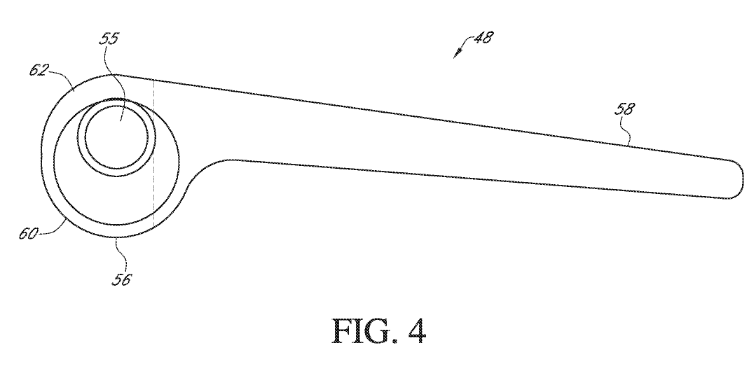

FIG. 5 is a side view of a clamp assembly, a rudder, and a fin box; and

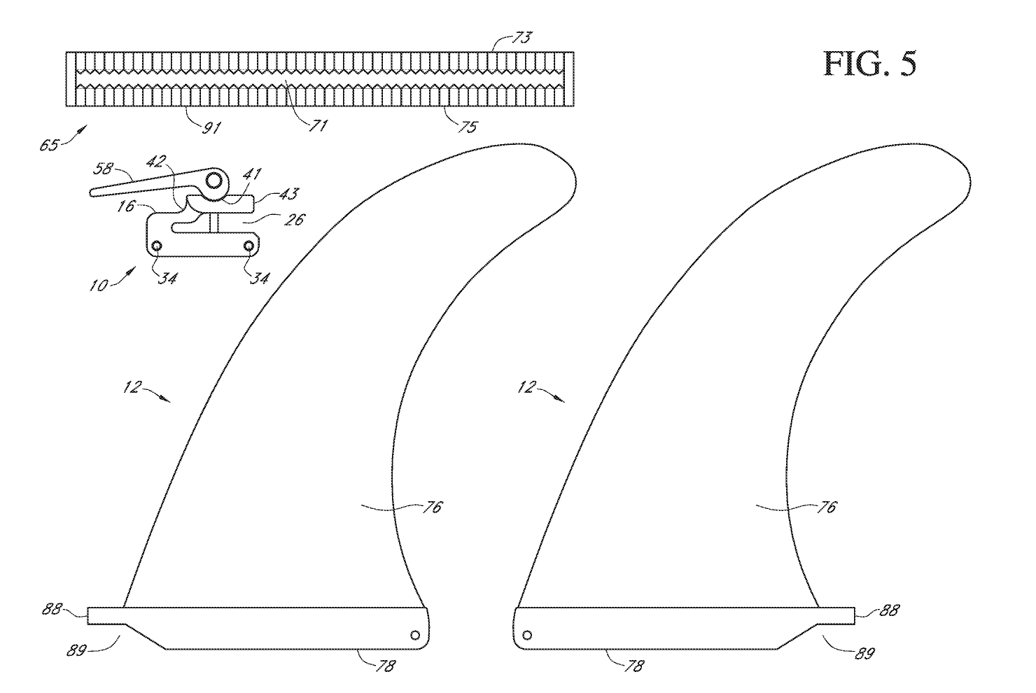

FIG. 6 is a side view of a fin box.

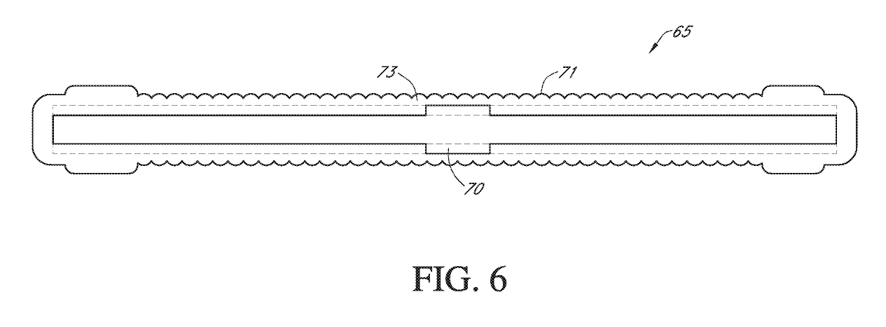

### DETAILED DESCRIPTION OF THE PREFERRED EMBODIMENT

Referring to the Figures, a clamp assembly 10 for securing a rudder 12 to an aquatic device 14 has a body 16 having a first end 18, a second end 20, a top 22 and a bottom 24. A slot 26 that extends from the first end 18 into the body 16 has a first section 28 and a second section 30. The height of the first section 28 of the slot 26 is greater than the height of the second section 30 which creates weakness within the body 16 for clamping. The slot 26 forms a bottom finger 32 between the slot 26 and the bottom 24 of the body 16. Positioned along the finger 32 is at least one and preferably two pins 34 that extend outwardly and transversely to the body 16. Also, the tip 36 of the finger 32 at the first end 18 is curved or chamfered.

The top 22 has a first section 38 and a second raised section 40 that are separated by a shoulder 42. Preferably, the raised section 40 corresponds with the second section 30 of the slot 26. A threaded bore 44 extends through the raised section 40 from the top 22 to the slot 26. Vertically aligned with bore 44 is a second threaded bore 46 that extends from slot 26 through finger 32.

Attached to the body 16 is a clamp 48. The clamp 48 has a threaded screw 50 that extends through an O-ring 52 and a socket 54. An end 53 of the screw 50 is connected to a pivot pin 55 in a spherical clamp head 56 that is moveably received within the socket 54 and terminates in a clamp handle 58. Preferably, the clamp head 56 has more than one and preferably two angles 60 and 62 that require greater force to rotate the head 56 within the socket 54 making the release of the clamp 48 from the body 16 more secure. In other embodiments, the screw 50 is a post that maintains a static position thereby eliminating the need to adjust the position of the spherical clamp head 56, which in turn provides consistent operation of the clamp 48 but eliminates the ability to fine-tune the clamping pressure.

In an alternative arrangement, the socket 54 is not present. Instead, the second raised section 40 has a recess 41 that is positioned rearwardly on the second raised portion 40 such that the recess 41 is closer to the shoulder 42 than an opposing side 43 of the second raised portion 40. By positioning the recess 41 closer to the shoulder 42, fine-tuned adjustment of the rudder 12 is provided as detailed further herein. Additionally, the absence of the socket 54 reduces the likelihood that a user of the clamp assembly 10 will attempt to unscrew the clamp 48 to align the socket 54 that can rotate when not clamped down. Still further, the absence of the socket 54 reduces drag against water during operation while also reducing the overall size of the clamp assembly 10.

In operation, the body 16 is inserted into a retaining slot 64 of a fin box 65 that is received on a bottom surface 66 of the aquatic device 14. The fin box 65 in some embodiments has an exterior surface 71 that is entirely ribbed or at least partially ribbed. In one particular arrangement, the exterior surface 71 along the length of the fin box 65 at a top edge 73 and a bottom edge 75 is the only ribbed portion.

The aquatic device 14 is of any type such as a surf board, paddle board, kayak, or the like. The retaining slot 64 has an elongated portion 68 that extends along the length of the device 14, a shorter portion 70 transverse to the elongated portion 68, and an internal portion 72 that runs parallel to and outside of the elongated portion 68.

In one embodiment, the short portion 70 is elongated in the direction of the elongated portion 68, which facilitates the insertion of the body 16 and rudder 12 as detailed further herein. In one embodiment, the short portion 70 has a rectangular shape such that a length of the short portion 70 is greater than a width of the short portion 70. In one particular embodiment, the short portion 70 has a length of 0.75 inches or approximately 0.75 inches.

The body 16 is inserted into the retaining slot 64 by aligning and inserting the pins 34 into the transverse portion 70 and once inserted moving the pins 34 along internal portion 72 and the body 16 along the elongated portion 68 to a forward end 74 of the retaining slot 64.

The rudder 12 is then inserted into the retaining slot 64. More specifically, the rudder 12 has a fin 76 that is connected to a support member 78 having a first end 80 and a second end 82. Adjacent the second end 82 is a pin 84 that extends outwardly and transversely to the support member 78. The pin 84 is aligned with and inserted into portion 70 of the retaining slot 64 and then slid to the second end 86 of the retaining slot 64 within the internal portion 72 of slot 64. The first end 80 of the support member 78 has a section 88 that is raised in relation to the rest of the support member 78 such that upon insertion into the fin box 65, the section 88 forms a gap 89 between a bottom 91 of the fin box 65. In this way, the gap 89 permits the finger 32 to be received at least partially between the section 88 and the bottom 91 of the fin box 65. Likewise, the section 88 is configured to be received within the first section 28 of the slot 26 to be retained by the clamp 48.

The fin 76 of the rudder 12, in some embodiments, has an arc or crescent shape which extends downwardly in relation to the bottom 91 of the fin box 65. The support member 78 in some embodiments is arranged such that the fin 76 extends towards the section 88 of the support member 78 such that during use, the fin 76 reduces friction and drag on the clamp assembly.

Once the rudder 12 is received within the retaining slot 64, the clamp assembly 10 is slid rearwardly within slot 64 to receive the raised section 88 of the support member 78 within slot 26 of the body 16. The curved or chamfered tip 36 of finger 28 helps to guide the raised section 88 into the slot 26. The clamp head 56 is then rotated clockwise using the clamp handle 58. The rotation of the head 56 causes the screw 50 to move downwardly through threaded bore 44. As the screw 50 moves downward the socket 54 and the head 56 are drawn downwardly against raised section 40 of the body 16 and the screw 50 engages the raised section 88 to apply a clamping force. The handle 58 is then rotated downwardly against the top 22 of the body 16 to apply further clamping force.

In embodiments without the socket 54, a similar operation occurs. Namely, the clamp head 56 is positioned to allow clamping, i.e., downward movement of the clamp handle 58, using the clamp handle 58. The clamp handle 58 is rotated or otherwise transitioned downwardly towards the top 22 of the body 16 and particularly upon the location of the recess 41, which reduces the height of the first section 28 and increases the clamping force applied to the support member 78 of the rudder 12. The cam-shape of the clamp head 56 in some arrangements facilitates the application of additional clamping force. The clamp head 56, as seen in the illustrative embodiment, is sized and shaped to be received and match the shape of the recess 41 when the clamp handle is moved downward towards the body 16.

For a more secure connection, the raised section 88 of the rudder 12 has a threaded bore 90 that is vertically aligned with bores 44 and 46 and receives screw 50.

In an alternative embodiment of the present invention, the body 16 has a length that extends between the first end 18 to the second end 20 that is 2.125 inches or approximately 2.125 inches. The fin box 65 has a length that extends between a first end 67 and a second end 69 of the fin box 65 that is 10.5 inches or approximately 10.5 inches in length and the retaining slot has a similarly oriented length of 10.125 inches or approximately 10.125 inches. In this configuration, the body 16 is capable of greater adjustment along the retaining slot of the fin box 65 than is possible with a longer body 16. This in turn provides for fine-tuned adjustment of the rudder 12 along the length of the retaining slot 64, which is beneficial due to the need to have the rudder 12 in different positions depending on the water and wave conditions that are to be encountered. Furthermore, when the recess 41 of the clamp 48 is positioned closer to the shoulder 42 additional space is provided to position the rudder 12 that would otherwise encounter the screw 50 of the clamp 48 at a shorter distance along the retaining slot 64.

In order to shorten the body 16, the slot 26 has a total length of 2.25 inches or approximately 2.25 inches extending from the front end 18 extending back towards the second end 20. The second section 30 of the slot 26 has a length of 0.5 inches or approximately 0.5 inches, which is necessary to permit clamping while still reducing the length of the body 16. In one embodiment, the slot 26 extends such that there is 0.5 inches or approximately 0.5 inches between the slot 26 and the second end 20 of the body 16.

When the length of the body 16 is reduced, the pins 34 are positioned such that one pin 34 is adjacent the first end 18 and another pin 34 is positioned adjacent the second end 20. In a particular embodiment, the pins 34 are within 0.125 inches or approximately 0.125 inches of the respective end 18, 20 and the bottom 24 of the body 16. The positioning of the pins 34 along with the shortened size of the body 16 in this arrangement facilitates insertion into the fin box 65 as the body 16 and the pins 34 are more easily manipulated into position.

In some embodiments, the width of the body 16 save for the raised section 40 has a width that is 0.15 inches or less when compared to the width of the retaining slot 64. These close tolerances facilitate the insertion and assembly of the body 16 with the fin box 65.

Accordingly, a clamp assembly for securing a rudder to an aquatic device has been disclosed that, at the very least, meets all the stated objectives.

What is claimed is:

1. A clamp assembly for securing a rudder to an aquatic device, comprising:
a body having a first end, a second end, a top, and a bottom;
a slot in the body that extends from the first end toward the second end; and
a clamp having a clamp handle operatively connected to the top of the body, wherein the clamp handle is configured to transition such that a clamping force is applied by reducing a height of the slot in the body.

2. The clamp assembly of claim 1 further comprising the top of the body having a recess.

3. The clamp assembly of claim 2 wherein the clamp handle has a clamp head that is configured to apply a force against the recess when the clamping force is applied.

4. The clamp assembly of claim 2 wherein the top of the body extends between a shoulder and an opposing side, and the recess is positioned closer to the shoulder than the opposing side.

5. The clamp assembly of claim 1 further comprising a fin box having a retaining slot, wherein the fin box is configured to be received in a bottom surface of the aquatic device.

6. The clamp assembly of claim 5 wherein the fin box has an exterior surface having at least a portion that is ribbed.

7. The clamp assembly of claim 6 wherein the portion that is ribbed extends along the length of the fin box at a top edge and a bottom edge.

8. The clamp assembly of claim 5 further comprising the retaining channel having a short portion that is configured to receive the body initially upon insertion of the body into the retaining channel.

9. The clamp assembly of claim 8 wherein the short portion has an elongated rectangular shape with a length of the short portion being greater than a width of the short portion.

10. The clamp assembly of claim 8 wherein the length of the short portion is approximately 0.75 inches.

11. The clamp assembly of claim 5 further comprising a rudder having a fin connected to a support member, wherein the support member has a section that is raised such that wherein when inserted into the fin box a gap is positioned between the support member and a bottom of the fin box.

12. The clamp assembly of claim 11 wherein the section of the support member that is raised is configured to be received in a first section of the slot of the body.

13. The clamp assembly of claim 11 further comprising the rudder having a fin that has a crescent shape which extends downwardly in relation to a bottom of the fin box and towards the body upon insertion into the fin box.

13. The clamp assembly of claim 1 wherein the slot of the body has a first section and second section, wherein a height of the first section is larger than a height of the second section.

14. The clamp assembly of claim 1 further comprising the clamp having a clamp head from which the clamp handle extends, wherein the clamp head has a cam-shape that is sized and shaped to be received in a recess of the body when the clamp handle is lowered.

15. The clamp assembly of claim 1 wherein the body has a length of approximately 2.125 inches between the first end and the second end, and the slot has a length of approximately 2.25 inches.

16. The clamp assembly of claim 5 wherein the retaining slot and a width of the bottom surface of the body have a tolerance of no greater than 0.15 inches.

17. The clamp assembly of claim 1 further comprising a first pin positioned through the body adjacent the first end and the bottom, and a second pin positioned through the body adjacent the second end and the bottom.

18. The clamp assembly of claim 17 wherein the first pin is positioned no more than 0.125 inches from the first end and the bottom.

19. The clamp assembly of claim 13 wherein the second section of the slot has a length of approximately 0.5 inches.

20. The clamp assembly of claim 13 wherein the slot extends such that approximately 0.5 inches extends between the slot and the second end of the body.
